(19) United States
(12) Patent Application Publication
(10) Pub. No.: US 2009/0292958 A1
(43) Pub. Date: Nov. 26, 2009

(54) ELECTRONIC APPARATUS AND STATE NOTIFICATION METHOD

(75) Inventor: Akemi Takahashi, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/353,199

(22) Filed: Jan. 13, 2009

(30) Foreign Application Priority Data
May 21, 2008 (JP) 2008-133333

(51) Int. Cl. G06F 11/08

(52) U.S. Cl. 714/56; 714/E11.03

(57) ABSTRACT

According to one embodiment, an electronic apparatus includes a timing detection module which detects a timing of notification to a user in association with execution of an application, a photographing module which captures an image at the timing of notification, which is detected by the timing detection module, a face image detection module which detects a face image of a person from the image which is captured by the photographing module, a direction detection module which detects a direction of the face on the basis of the face image, a setting module which sets a notification method in accordance with the direction of the face, which is detected by the direction detection module, and a notification module which gives a notice according to the notification method which is set by the setting module.

### CROSS-REFERENCE TO RELATED APPLICATIONS

This application is based upon and claims the benefit of priority from Japanese Patent Application No. 2008-133333, filed May 21, 2008, the entire contents of which are incorporated herein by reference.

### BACKGROUND

1. Field

One embodiment of the present invention relates to an electronic apparatus such as a personal computer, and a state notification method which is executed in the electronic apparatus.

2. Description of the Related Art

In an electronic apparatus such as a personal computer, in a case where a wait state occurs until a process is completed, a notice is given to the user when the process is completed. For example, when data is recorded on an optical disc, such as a DVD (Digital Versatile Disc), by using a personal computer, in a case where a plurality of optical discs are needed, each time data write on one optical disc is completed, a notice is given to the user by a message displayed on the screen or by output of sound, thereby prompting the user to change the optical disc.

In the case of notification by sound, if a large sound is output, the user can be made to exactly recognize the notification. However, if a large sound is produced when the user is in the vicinity of the electronic apparatus, the notification by sound is annoying.

Conventionally, there has been thought an information terminal device which varies the volume of a sound output in accordance with the distance between the information terminal device and the user. For example, in an information terminal device disclosed in Jpn. Pat. Appln. KOKAI Publication No. 2003-15911, the distance to the user is detected by a human body sensor, and the volume of a sound output of a sound output device is adjusted in accordance with the detected distance.

As has been described above, in the conventional information terminal device, the distance between the device and the user is detected, and the volume of the sound output can be adjusted in accordance with the detected distance. However, if the volume is simply adjusted in accordance with the distance from the user, a proper notice to the user cannot be given.

For example, in the case where the user is in the vicinity of the electronic apparatus, sound is output with a small volume, but in this case it is possible that the user may not be aware of the sound unless the user pays attention to the operation state of the electronic apparatus.

In addition, in the case where the user moves away from the electronic apparatus, it is possible that the user does not aware of the notification even if the sound volume is increased to a maximum. Besides, in the case where a person, who is different from the user, is in the vicinity of the electronic apparatus, sound may be produced with a volume adjusted to that person. It is thus difficult to give a proper notice corresponding to the condition of the user

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing the state in which a display unit of a personal computer according to an embodiment of the invention is opened;

FIG. 2 is an exemplary block diagram showing the system configuration of the personal computer according to the embodiment;

FIG. 3 is an exemplary data structure showing a notification management data in the embodiment;

FIG. 4 is an exemplary data structure showing a terminal notification data in the embodiment;

FIG. 5 is an exemplary data structure showing a face data in the embodiment;

FIG. 6 is an exemplary data structure showing a application management data in the embodiment;

FIG. 7 is an exemplary flow chart showing a state notification setting process in the embodiment;

FIG. 8 is an exemplary flow chart showing a face data recording process in the embodiment;

FIG. 9 is an exemplary flow chart showing a state notification process in the embodiment;

FIG. 10 shows an example of the case in which the face is in a frontal direction in the embodiment;

FIG. 11 shows an example of the case in which the face is turned obliquely to the lateral side in the embodiment; and

FIG. 12 is an exemplary flow chart showing a user determination/notification process in the embodiment.

### DETAILED DESCRIPTION

Various embodiments according to the invention will be described hereinafter with reference to the accompanying drawings. In general, according to one embodiment of the invention, there is provided an electronic apparatus comprising, a timing detection module which detects a timing of notification to a user in association with execution of an application, a photographing module which captures an image at the timing of notification, which is detected by the timing detection module, a face image detection module which detects a face image of a person from the image which is captured by the photographing module, a direction detection module which detects a direction of the face on the basis of the face image, a setting module which sets a notification method in accordance with the direction of the face, which is detected by the direction detection module, and a notification module which gives a notice according to the notification method which is set by the setting module.

An embodiment will now be described with reference to the accompanying drawings.

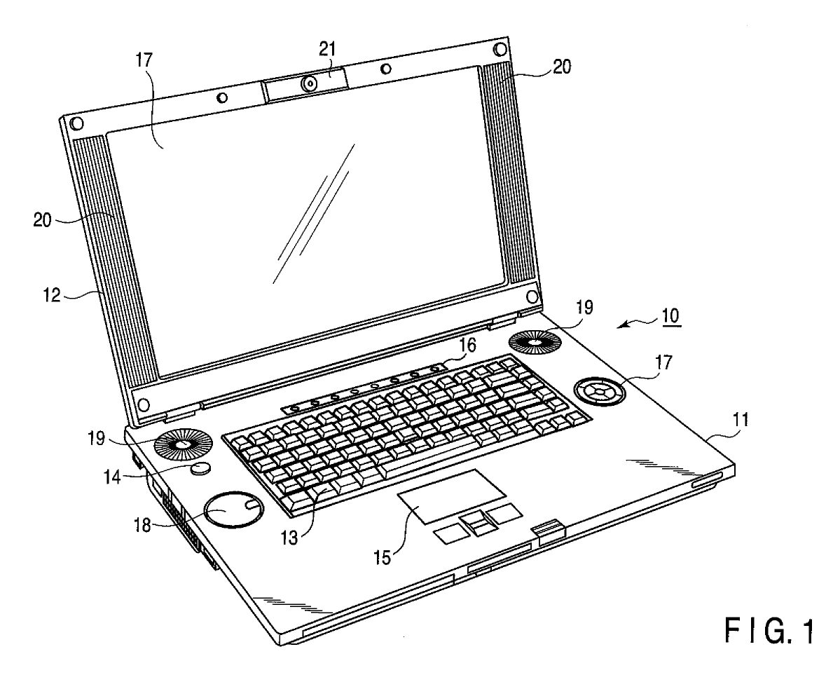

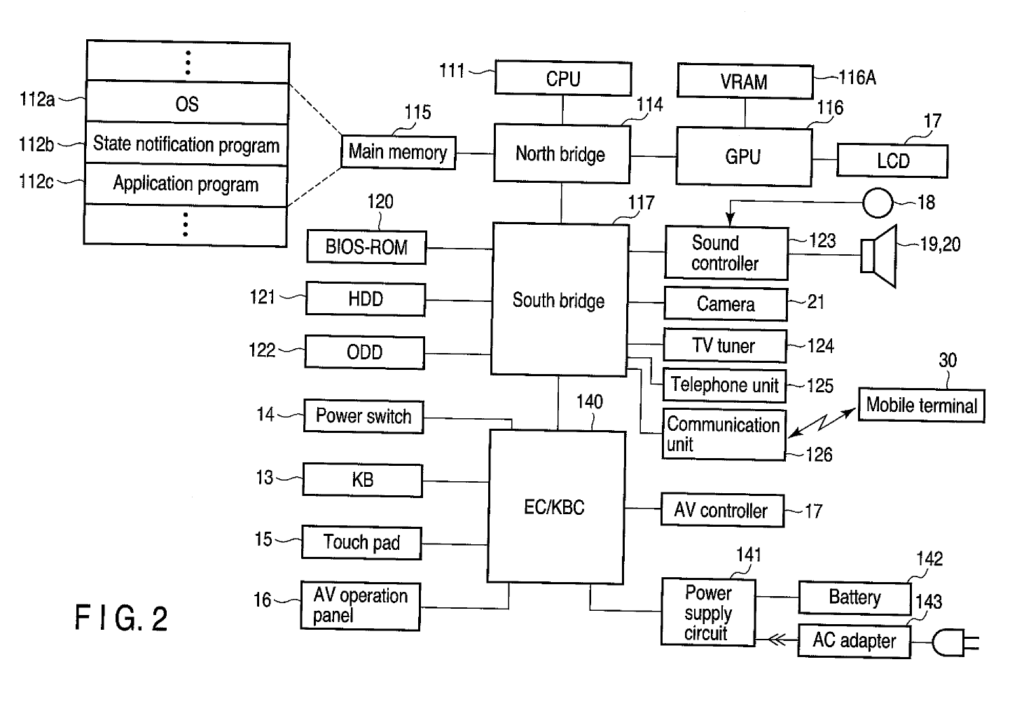

To begin with, referring to FIG. 1 and FIG. 2, the structure of an electronic apparatus according to an embodiment of the invention is described. The electronic apparatus is realized, for example, as a notebook personal computer 10.

FIG. 1 is a perspective view that shows the state in which a display unit of the notebook personal computer 10 is opened. The computer 10 comprises a computer main body 11 and a display unit 12. A display device that is composed of an LCD (Liquid Crystal Display) 17 is built in the display unit 12. The display screen of the LCD 17 is positioned at an approximately central part of the display unit 12. A pair of speakers (tweeters) 20 are disposed on both sides of the LCD 17.

The display unit 12 is attached to the computer main body 11 such that the display unit 12 is freely rotatable between an open position and a closed position. The computer main body 11 has a thin box-shaped casing. A keyboard 13, a power button 14 for powering on/off the computer 10, a touch pad 15, an audio/video (AV) operation panel 16, an AV controller 17, a volume control dial 18 and a pair of speakers 19 are disposed on the top surface of the casing of the computer main body 11. A camera 21 is provided on the display unit 12 at an upper side portion thereof in the open position of the display unit 12. The camera 21 can capture an image of not only the surrounding of a user who is using the personal computer 10, but also an image of a range at a certain distance from the personal computer 10. Accordingly, the camera 21 can capture an image including a user who is at a certain distance from the personal computer, if the user is present in a direction facing the display screen of the display unit 12.

Next, referring to FIG. 2, the system configuration of the computer 10 is described.

The computer 10 comprises a CPU 111, a north bridge 114, a main memory 115, a graphics processing unit (GPU) 116, a south bridge 117, a BIOS-ROM 120, a hard disk drive (HDD) 121, an optical disc drive (ODD) 122, a sound controller 123, a TV tuner 124, an embedded controller/keyboard controller IC (EC/KBC) 140, and a power supply circuit 141.

The CPU 111 is a processor that is provided for controlling the operation of the computer 10. The CPU 111 executes an operating system (OS) 112a, a state notification program 112b and various application programs 112c, which are loaded from the HDD 121 into the main memory 115. The state notification program 112b is a program which is executed in a case where the end of a process in association with the execution of, e.g. the application program 112c, needs to be reported to the user. In this case, the state notification program 112b detects the timing of notification, and gives a notice by a notification method corresponding to the state of the user. On the basis of an image that is captured by the camera 21, the state notification program 112b detects the state of the user, and selects a notification method in accordance with the detected state. As the notification method, for instance, sound, display or a mobile terminal is selectively used. In addition, the CPU 111 executes a BIOS (Basic Input/Output System) that is stored in the BIOS-ROM 120.

The north bridge 114 is a bridge device that connects a local bus of the CPU 111 and the south bridge 117. The north bridge 114 includes a memory controller that access-controls the main memory 115. The north bridge 114 also has a function of executing communication with the graphics processing unit (CPU) 116 via, e.g. a PCI Express bus.

The graphics processing unit (CPU) 116 is a display controller which controls the LCD 17 that is used as a display monitor of the computer 10. The CPU 116 generates a video signal, which forms a screen image that is to be displayed on the LCD 17, on the basis of display data that is written in a video memory (VRAM) 116A by the OS or the application program.

The south bridge 117 includes an IDE (Integrated Drive Electronics) controller or a Serial ATA controller for controlling the hard disk drive (HDD) 121 and optical disc drive (ODD) 122.

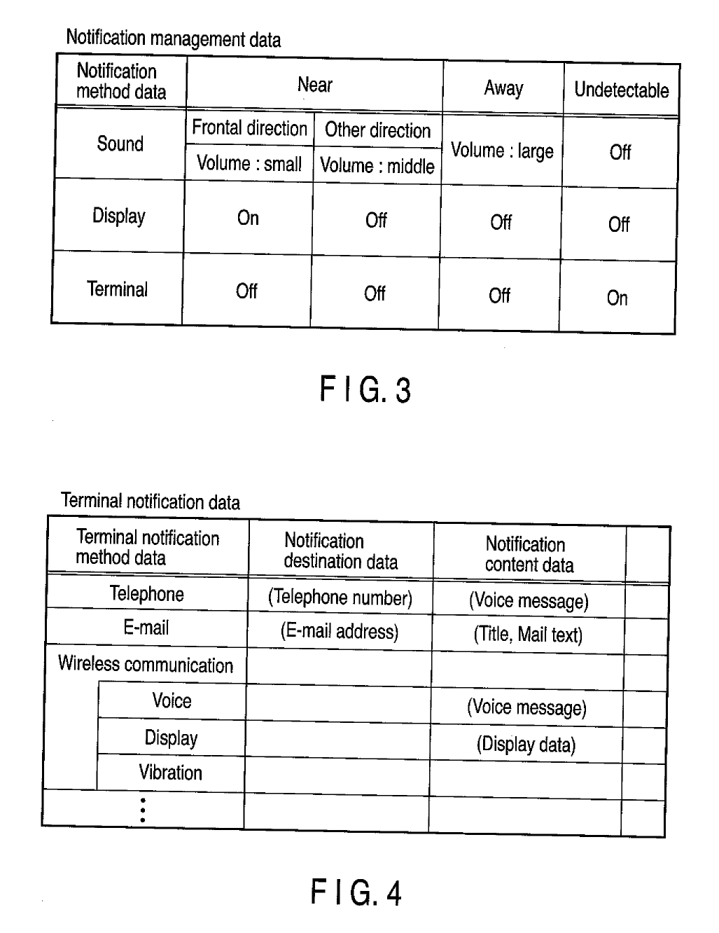

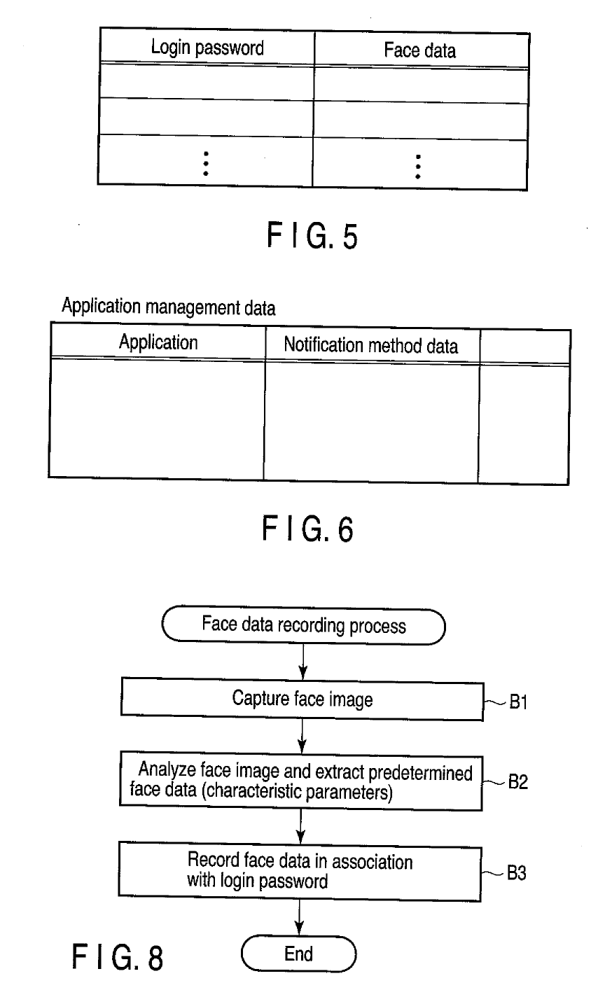

The HDD 121 is a storage device which stores various programs and data. The HDD 121 stores various control data for controlling, for example, the notification by the state notification program 112b. The control data includes, for instance, notification management data, terminal notification data, face data and application management data. The details of each control data will be described later (FIG. 3, FIG. 4, FIG. 5 and FIG. 6).

The optical disc drive (ODD) 122 is a drive unit for driving storage media, such as a DVD, in which video content is stored.

The sound controller 123 is a sound source device and executes a process for outputting sound, which corresponds to various audio data, from the speakers 19 and 20. The TV tuner 124 receives broadcast program data which is broadcast by a TV broadcast signal.

A telephone unit 125 is connected to a public telephone network by wire or by radio, and executes, for example, signal transmission to a mobile phone.

A communication unit 126 is a unit which controls short-distance wireless communication, such as Bluetooth®, and executes communication with a mobile terminal 30 such as a mobile phone which is equipped with a short-distance wireless communication unit.

The embedded controller/keyboard controller IC (EC/KBC) 140 is a 1-chip microcomputer in which an embedded controller for power management and a keyboard controller for controlling the keyboard (KB) 13 and touch pad 15 are integrated. The EC/KBC 140 is always supplied with operation power from the power supply circuit 141 even in the state in which the computer 10 is powered off. The EC/KBC 140 functions as a controller for controlling the AV operation panel 16. Communication between the EC/KBC 140 and AV controller 20 is executed via, e.g. a serial bus.

The EC/KBC 140 has a function of powering on/off the computer 10 in response to the user's operation of the power button switch 14. The power on/off control of the computer 10 is executed by cooperation of the EC/KBC 140 and power supply circuit 141. The power supply circuit 141 uses power from a battery 142 which is mounted in the computer main body 11 or power from an AC adapter 143 which is connected to the computer main body 11 as an external power supply, thereby generating operation powers to the respective components.

Next, a description is given of the various control data for controlling the notification by the state notification program 112b.

FIG. 3 shows an example of notification management data. The notification management data is data in which notification methods are set, which are used in accordance with the state of the user. The state of the user is detected on the basis of an image captured by the camera 21. In the notification management data shown in FIG. 3, “sound”, “display” and “terminal” are set as notification methods. The notification content of each notification method can individually be set with respect to the condition of the user that is detected on the basis of the captured image, that is, with respect to a case in which the user is determined to be present within a predetermined range (i.e. the user is nearby), a case in which the user is determined to be not present within the predetermined range (i.e. the user is away), and a case in which the user is undetectable. Furthermore, in the case where the user is determined to be present within the predetermined range, the notification content is set with respect to a case in which the face is in a frontal direction, that is, a case in which the user is assumed to look at the display screen of the LCD 17, and a case in which the face is in another direction.

For example, in the case of using the notification method by “sound”, if the user is nearby and faces in the frontal direction, it is highly possible that the user is viewing the LCD 17, and thus sound is set to be produced with a small volume. In the case where the user is nearby but does not face in the frontal direction, it is assumed that the user does not view the screen of the LCD 17, and thus sound is set to be produced with a middle volume. In the case where the user is away (not present in the predetermined range), sound is set to be produced with a large volume. In the case where the user is undetectable, the notice by “sound” is not given. In this case, a notice by “terminal”, instead of “sound”, is set to be given.

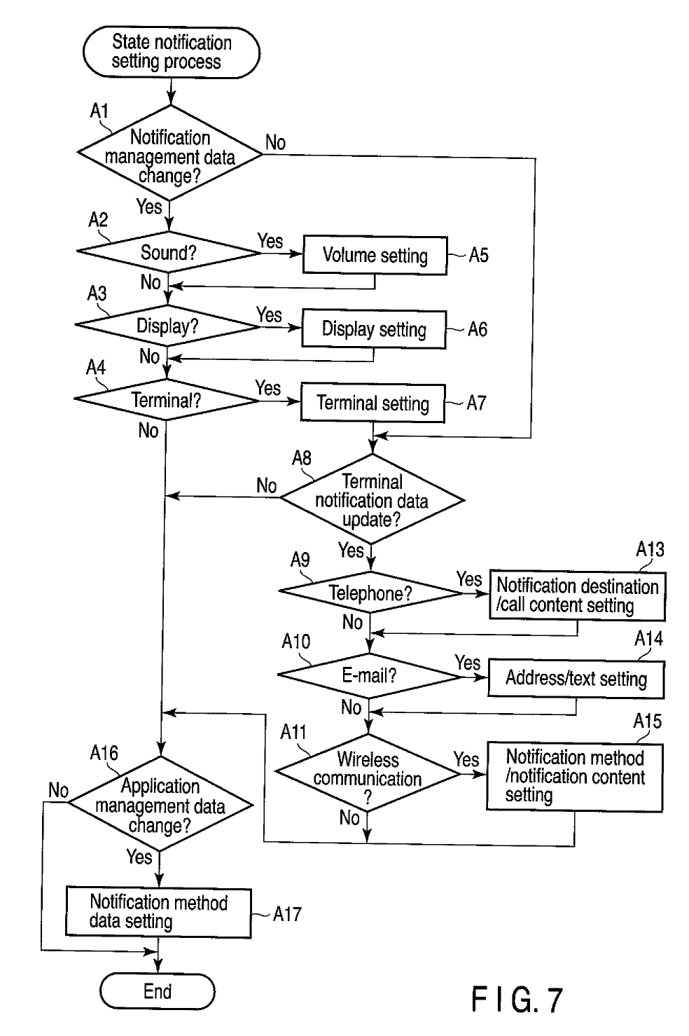

The content of settings shown in FIG. 3 is merely an example and it can arbitrarily be set by the user in a state notification setting process which will be described later (see FIG. 7). The notification method is not limited to one, and a plurality of notification methods may be combined in use.

FIG. 4 shows an example of the terminal notification data. The terminal notification data is data in which terminal use modes (terminal notification methods) are set in the case where “terminal” is set as the notification method. In the terminal notification data shown in FIG. 4, “telephone”, “e-mail” and “wireless communication” are prepared as terminal notification methods, and any one of them is selected.

Notification destination data (telephone number) and notification content data (voice message), which are associated with the case where “telephone” is used as the terminal notification method, are set. In addition, notification destination data (e-mail address) and notification content data (mail title/text), which are associated with the case where “e-mail” is used as the terminal notification method, are set. In the case where “wireless communication” is used as the terminal notification method, it is possible to set a notification method by any one of “voice”, “display” and “vibration (vibrator function)”, by making use of the mobile terminal 30 (mobile phone) which is connected by short-distance wireless communication (Bluetooth®, etc.)

Since the notification destination data can arbitrarily be set in the terminal notification data, a notice can be given, for example, not only to the user who has logged in to the personal computer 101 but also to another person. For example, in the case where data write is executed on a plurality of DVDs, a notice may be given to a person other than the user, so that the person may be asked to do a work for loading a DVD in the optical disc drive 122. Further, by setting a plurality of notification destination data, a notice may be given to a plurality of persons at the same time.

FIG. 5 shows an example of face data. The face data is data representative of the features of the user's face, which is used in a collation process for discriminating the user on the basis of a face image that is included in the image captured by the camera 21. The face data includes, for instance, position data, which are indicative of the positions of the eyes, nose and mouth and the relative relationship between the eyes, nose and mouth, and color data, which are detected from the face image. Further, the face data may include other data which is effective in discriminating the user.

In the example shown in FIG. 5, face data are set in association with a plurality of login passwords. In the case where the user can be discriminated by using any one of the face data with respect to a face image that is captured by the camera 21, it is determined whether the login password corresponding to the face data that is used in the discrimination of the user agrees with the login password that is input at the time of login to the personal computer 10. Thereby, it can be determined whether the person who is near the personal computer 10 is the login user. In accordance with the determination result, the notification method can be set. The login password is set on a user-by-user basis, and the input of the login password is required at the time of login to the personal computer 10.

FIG. 6 shows an example of application management data. The application management data is data in which a notification method for notification to the user in association with the execution of an application is set on an application-by-application basis. For example, such settings can be made that notices are given by using different communication methods when an application for writing data on a DVD is executed and when an application for recording TV broadcast data (broadcast program data) that is received by the TV tuner 124 is executed. The notification method data in FIG. 6 indicates one of notification methods, i.e. “sound”, “display” and “terminal”, which are shown in FIG. 3.

Next, a description is given of the operations of processes relating to the state notification of the personal computer 10 in the present embodiment. The processes, which are described below, are realized by the execution of the state notification program 112b by the CPU 111.

To begin with, the state notification setting process in the present embodiment is described with reference to a flow chart of FIG. 7. The state notification setting process is a process for setting a notification method at a time of notification to the user in association with the execution of the application, that is, the notification management data (FIG. 3), the terminal notification data (FIG. 4) and the application management data (FIG. 6), in accordance with instructions from the user.

To start with, if the start of the state notification setting process is requested by the user, for example, by an operation on the keyboard 13, the CPU 111 causes the LCD 17 to display, e.g. a setting screen. On the setting screen, one of the notification management data, the terminal notification data and the application management data can arbitrarily be selected as data that is an object of setting.

If the setting of the notification management data is instructed (Yes in block A1), the CPU 111 causes the LCD 17 to display a screen for setting the notification management data. On the screen for setting the notification management data, a notification method, i.e. one of “sound”, “display” and “terminal”, can arbitrarily be selected as the object of setting.

If the notification method “sound” is selected (Yes in block A2), the CPU 111 sets, for example, in accordance with the user's instruction by means of the keyboard 13, the volume (large, middle, small) of sound or the mute of sound with respect to the cases of “near” (“frontal direction” or “other direction”), “away” and “undetectable”, in connection with the notification method data “sound” shown in FIG. 3. In this case, it is assumed that the volume level is arbitrarily adjustable.

If the notification method “display” is selected (Yes in block A3), the ON/OFF of notification by “display” and the content (e.g. message or image) of “display” can be set in like manner (block A6).

If the notification method “terminal” is selected by Yes in block A4), the ON/OFF of notification by use of the mobile terminal 30 can be set in like manner (block A7).

If the setting of the terminal notification data is instructed (Yes in block A8), the CPU 111 executes display of a screen for setting the terminal notification data. On the screen for setting the terminal notification data, a terminal notification method, i.e. one of “telephone”, “e-mail” and “wireless communication”, can arbitrarily be selected as an object of setting.

If the terminal notification method “telephone” is selected (Yes in block A9), the CPU 111 sets, in accordance with the user's instruction, the notification destination data (telephone number) and notification content data (voice message) in connection with the terminal notification method data “telephone” (block A13)

If the terminal notification method “e-mail” is selected (Yes in block A10), the CPU 111 can set the notification destination data (e-mail address) and notification content data (title and mail text) in connection with the terminal notification method data “e-mail” (block A14).

If the terminal notification method “wireless communication” is selected (Yes in block A11), the CPU 111 can set a notification method by any one of “voice”, “display” and “vibration (vibrator function)”, by making use of the mobile terminal 30 (block A15). In the case where “wireless communication” is set as the terminal notification method, the CPU 111 controls the mobile terminal 30 which is connected via the communication unit 126, and gives a notice to the user by making use of the function that is provided in the mobile terminal 30.

If the setting of the application management data is instructed (Yes in block A16), the CPU 111 sets an application and a notification method (notification method data) which is used at a time of notification in association with the execution of the application, in accordance with the user's instruction, as shown in FIG. 6 (block A17).

As has been described above, the notification management data, terminal notification data and application management data can be set in accordance with the user's instruction. Thereby, a proper notification method corresponding to the state of the user can be set.

Next, a face data recording process in the present embodiment is described with reference to a flow chart of FIG. 8. The face data recording process is a process for pre-recording face data which is referred to in order to discriminate the user on the basis of a face image that is captured by the camera 21.

To start with, if the execution of the face data recording process is requested by the user, for example, by the operation on the keyboard 13, the CPU 111 executes capturing of an image by the camera 21 (block B1). The CPU 111 extracts a face image, which corresponds to the part of the face of the user, from the image that is captured by the camera 21, analyzes the face image, and extracts predetermined face data (characteristic parameters). In a method of extracting the face image, for example, color information is used to extract, as a face image candidate, an image area corresponding to the flesh color, and further image areas corresponding to the parts of the eyes, nose and mouth are detected, thereby selecting a face image candidate including such image areas of the eyes, etc. Some other extraction method may also be used. The face data (characteristic parameters) may be, for instance, position data indicative of the relative relationship between the parts of the eyes, mouse and mouth, and color data of areas corresponding to the respective parts. Needless to say, as the face data, other data indicative of the features of the face may be used in accordance with the method of a collation process.

The CPU 111 records the face data, as shown in FIG. 5, in association with the user password which is input at the time of login to the personal computer 10 (block B3).

The face data, which is pre-recorded by the face data recording process, is used in the user determination in a state notification process (user determination/notification process) which is described later.

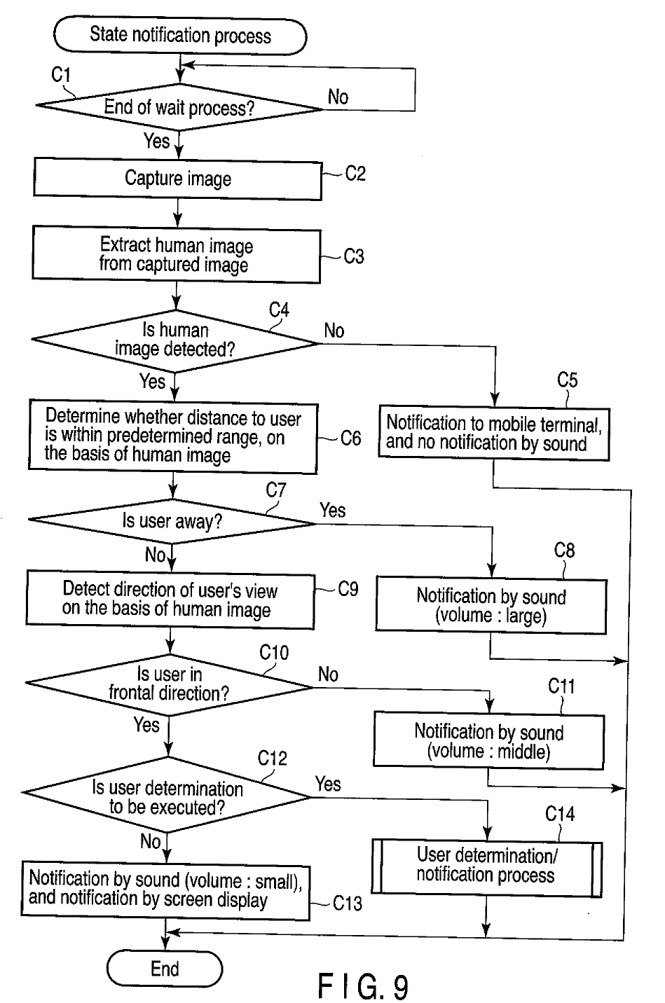

Next, the state notification process in the present embodiment is described with reference to a flow chart of FIG. 9. The state notification process is a process which is executed along with various applications in order to give a notice by using an optimal notification method corresponding to the state of the user, in a case where it is necessary to give a notice in the application.

It is assumed that an application is being executed and a process which sets the user in a wait state is being executed. For example, it is assumed that a process of writing data on a DVD is being executed in the optical disc drive (ODD) 122. In the state notification process, while the application is being executed, a timing of notification to the user in association with the execution of the application is detected. For example, a timing of notification to the user is detected at the completion of data write on the DVD.

If the end of the process, which sets the user in the wait state, is detected, that is, if the timing of notification is detected (Yes in block C1), the CPU 111 executes capturing of an image by the camera 21 (block C2).

The CPU 111 detects a human image corresponding to a person, from the image captured by the camera 21 (block C3). In this case, for example, by making use of color image (flesh color image) of the image, an image including an area corresponding to the face image is detected as a human image.

If a human image is not detected (No in block C4), it is determined that the user is not in the vicinity of the personal computer 10, and the notification method “terminal” is set according to the notification management data shown in FIG. 3.

If “terminal” is set as the notification method, the CPU Ill refers to the terminal notification method data that is set in the terminal notification data shown in FIG. 4, and sets the notification method which makes use of the mobile terminal 30.

For example, in the case where “e-mail” is set as the terminal notification method, the CPU 111 creates an e-mail according to the title and mail text indicated by the notification content data, and sends the e-mail via the telephone unit 125 to the mail address destination indicated by the notification destination data (block C5).

The user of the personal computer 10 carries the mobile terminal 30 which can receive an e-mail. Thereby, even if the user is present at a position which is entirely different from the position of the personal computer 10, the user can be informed of the completion of the process by the application which is being executed. In the case where the terminal notification method “telephone” or “wireless communication” is set in the terminal notification data, a notice is given to the user by the corresponding notification method by making use of the mobile terminal 30, although a detailed description is omitted.

On the other hand, if a human image (face image) is detected from the image that is captured by the camera 21 (Yes in block C4), the CPU 111 determines, on the basis of the human image (face image), whether the distance to the user is within a predetermined range or not (block C6). For example, on the basis of the area size of the face image extracted from the image, if the area size is less than a reference value, it is determined that the user is farther than the predetermined range. In a method of detecting the distance between the user and the personal computer 10, an infrared sensor, for instance, may be used in combination in measuring the distance.

If it is determined that the user is away (Yes in block C7), the CPU 111 sets the notification method “sound” and sets the volume “large” according to the notification management data shown in FIG. 3. The CPU 111 controls the sound controller 123 to cause the speakers 19 and 20 to produce sound with a large volume for reporting the end of the process (block C8).

If the distance to the user is determined to be within the predetermined range on the basis of the human image (face image) (No in block C7), the CPU 111 detects the direction of the user's view on the basis of the human image (face image) (block C9). For example, the CPU 111 extracts images of the parts, such as the eyes, nose and mouth, from the face image, and can determine the direction of the user's view on the basis of the positional relationship between these parts.

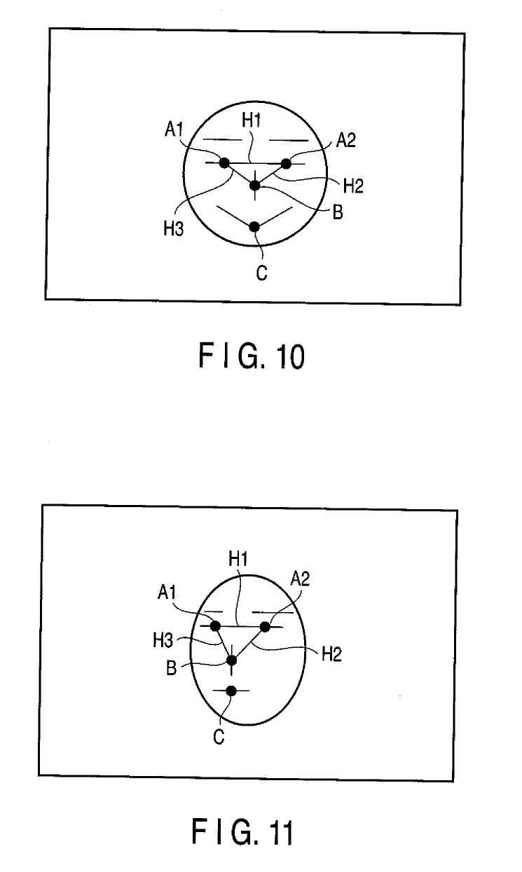

FIG. 10 shows the case in which the face is in a frontal direction, and FIG. 11 shows the case in which the face is turned obliquely to the lateral side. Each of FIG. 10 and FIG. 11 shows the positions of the right and left eyes Al and A2, the nose B and the mouth C. In FIG. 10 and FIG. 11, H1 indicates the distance between the eyes A1 and A2, H2 indicates the distance between the left eye A2 and the nose B, and H3 indicates the distance between the right eye A1 and the nose B.

As is understood from the comparison between FIG. 10 and FIG. 11, the distances H1, H2 and H3 are different between the case in which the user is in the frontal direction and the case in which the user is not in the frontal direction. For example, as shown in FIGS. 10 and 11, the CPU 111 can determine whether the user is in the frontal direction or not, on the basis of the differences in the positions of the parts (eyes, nose and mouth) of the face and the distances between the parts, for example, as shown in FIG. 10 and FIG. 11.

Methods, other than the above-described method, may be used as the method of detecting the direction of the user's face.

If it is determined that the user is not in the frontal direction (No in block C10), the CPU 111 sets the notification method “sound” and sets the volume “middle” according to the notification management data shown in FIG. 3. Specifically, it is possible that although the user is in the vicinity of the personal computer 10, the user does not view the display on the LCD 17 and pays no attention to the operation of the personal computer 10. Thus, sound with a middle volume is produced to exactly report to the user. The CPU 111 controls the sound controller 123 to cause the speakers 19 and 20 to produce sound with a middle volume for reporting the end of the process (block C11).

On the other hand, if it is determined that the user is in the frontal direction (Yes in block C10), the CPU 111 determines whether or not to execute user determination on the basis of the face image. For example, in the case where the face data is not pre-recorded by the face data recording process or in the case where such a setting is made in advance that the user determination is needless, the CPU 111 determines that the user determination is not executed (No in block C12).

In this case, the CPU 111 sets the notification method “sound” and sets the volume “small” according to the notification management data shown in FIG. 3. Specifically, it is highly possible that the user is in the vicinity of the personal computer 10 and looks at the display on the LCD 17. Accordingly, even if the volume is small, it is possible to exactly report to the user. In other words, the user is not annoyed by excessive notification with a large sound volume. In addition, since it is highly possible that the user looks at the LCD 17, a notice by screen display according to the notification method “display” is given in parallel with the notice by sound.

If it is determined that the user determination is executed (Yes in block C12), the CPU 111 executes the user determination/notification process by making use of the face data that is pre-recorded (block C14).

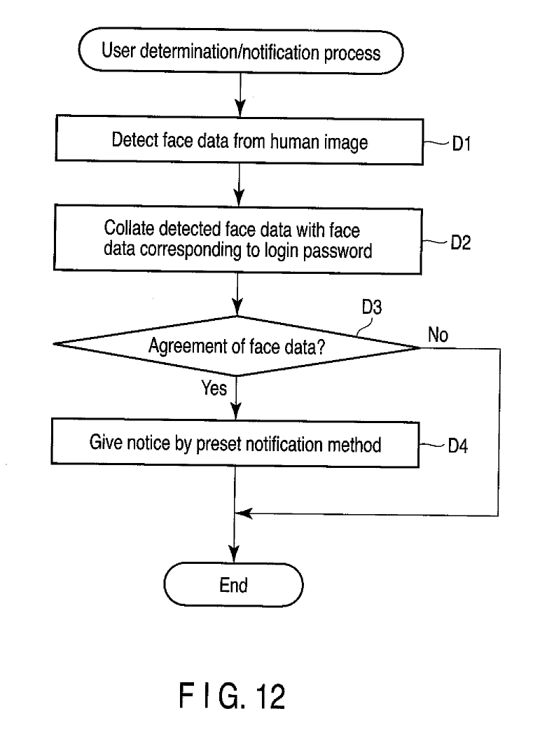

FIG. 12 is a flow chart for describing the user determination/notification process in the present embodiment.

To start with, the CPU 111 detects face data (characteristic parameters), which represent the features of the face, from the face image in the image that is captured by the camera 21 (block D1). The CPU 111 collates the face data of the captured face image and the face data that is pre-recorded in association with the login password that is input at the time of login, thereby determining these face data agree nor not. Specifically, it is determined whether the person who is present in the vicinity of the personal computer 10 is the proper user who has logged in to the personal computer 10.

If the face data are determined to agree (Yes in block D3), the CPU 111 executes notification by the preset notification method (block D4). For example, in the same manner as described above, a notice by sound with a small volume is given at the same time as the notice by screen display. If the face data do not agree (No in block D3), no notice is given, and thereby it becomes possible to prevent a person, who does not need notification, from being annoyed by the notification. In this case, by executing notification with use of the mobile phone 30, it becomes possible to report to the proper user.

In the flow chart of FIG. 12, notification is executed when the face data agree, that is, when it is determined that the proper user is in the vicinity of the personal computer 10. In the case where the face data do not agree, that is, in the case where it is determined that a person other than the proper user is in the vicinity of the personal computer 10, a notice may be given by the notification method “terminal”. At this time, the user may be informed that the condition is not normal, by giving a notification content which is different from an ordinary notification content.

Specifically, when the proper user is away from the personal computer 10, it is possible to detect that some other person is in the vicinity of the personal computer 10 and to report this fact to the proper user.

As described above, according to the personal computer 10 of this embodiment, when it is necessary to give a notice to the user in association with the execution of the application, a notice by sound with a small volume may be given to the user in the condition in which the user is in the vicinity of the personal computer 10 and is viewing the screen, thereby preventing the user from being annoyed with excessive notification. In addition, even in the case where the user is in the vicinity of the personal computer 10, if the face is not directed to the screen, a notice by sound with a larger volume can be given, and it is possible to more exactly notify the user. Besides, in the case where the user is away from the personal computer more than the predetermined range of distance, a notice by sound with a still larger volume can be given, and it is possible to exactly notify the user. Even in the case where the user is away from the personal computer 10 to such a distance that a notice by sound cannot be given, it is possible to exactly notify the user by using the mobile terminal 30.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic apparatus comprising:
a timing detection module configured to detect a timing of notification to a user in association with execution of an application;
a camera configured to capture an image at the detected timing of notification;
a face image detection module configured to detect a face image from the captured image;
a direction detection module configured to detect a direction of the face based on the face image;
a setting module configured to set a notification method in accordance with the direction of the face; and
a notification module configured to notify according to the notification method.

2. The electronic apparatus of claim 1, further comprising a determination module configured to determine whether a distance to the user is within a predetermined range based on the captured image,
wherein the face image detection module is configured to detect the face image when the determination module determines that the distance is within the predetermined range.

3. The electronic apparatus of claim 2, wherein the setting module is configured to set a second notification method, different from a first notification method used when the determination module determines that the distance is within the predetermined range, when the determination module determines that the distance is not within the predetermined range.

4. The electronic apparatus of claim 3, wherein the setting module is configured to set either the first or second notification method using a terminal device when the user is undetectable based on the captured image.

5. The electronic apparatus of claim 1, further comprising:
a face data recording module configured to record face data representative of features of the face of the user; and
a user identification module configured to identify the user by using the face data recorded in the face data recording module, with reference to the captured image,
wherein the setting module is configured to set the notification method in accordance with the identified user.

6. The electronic apparatus of claim 5, further comprising a password input module configured to allow a user to input a login password for each user at a time of login,
wherein the face data recording module is configured to record the face data in association with the login password, and
the setting module is configured to set the notification method based on whether the login password entered at the password input module agrees with the login password associated with the face data used in the identification of the user.

7. A state notification method comprising:
detecting a timing of notification to a user in association with execution of an application;
capturing an image at the detected timing of notification;
detecting a face image from the captured image;
detecting a direction of the face based on the face image;
setting a first configuration in order to set a notification method in accordance with the detected direction of the face; and
notifying according to the notification method of the first configuration.

8. The state notification method of claim 7, further comprising determining whether a distance to the user is within a predetermined range based on the captured image,
wherein the detecting the face image comprises detecting the face image when it is determined that the distance is within the predetermined range.

9. The state notification method of claim 8, wherein the setting first configuration comprising setting a second notification method, different from a first notification method set when it is determined that the distance is within the predetermined range, when it is determined that the distance is not within the predetermined range.

10. The state notification method of claim 9, wherein the setting first configuration comprises setting a notification method using a terminal device when the user is undetectable based on the captured image.

11. The state notification method of claim 7, further comprising:
first face data recording in order to record face data representative of features of the face of the user;
identifying the user by using the face data recorded by the first face data recording, with reference to the captured image; and
setting second configuration in order to set the notification method in accordance with the identified user.

12. The state notification method of claim 11, further comprising:
second face data recording in order to record the face data in association with a login password for each user;
inputting the login password at a time of login; and
setting third configuration in order to set the notification method according to whether the entered login password corresponds with the login password associated with the face data used in the identification of the user.
